(19) United States
(12) Patent Application Publication
(10) Pub. No.: US 2024/0357392 A1
(43) Pub. Date: Oct. 24, 2024

(54) Attention (AT) Command For Managing Data Measurement Reporting

(71) Applicant: HUAWEI TECHNOLOGIES CO., LTD., Shenzhen, Guangdong (CN)

(72) Inventors: Charles Nung LO, San Diego, CA (US); Lenaig Genevieve CHAPONNIERE, La Jolla, CA (US); Shankar KRISHNAN, San Diego, CA (US); Jianhua LIU, Beijing (CN)

(21) Appl. No.: 18/294,136

(22) PCT Filed: Jul. 18, 2022
(86) PCT No.: PCT/CN2021/106204

§ 371 Date: Jan. 31, 2024

(30) Foreign Application Priority Data
Jul. 15, 2021 (CN) 202010681305.9

(51) Int. Cl. H04W 24/10

(52) U.S. Cl. CPC H04W 24/10

(57) ABSTRACT

Various embodiments of methods of managing data measurement reporting may include sending from an application processor of a user equipment (UE) to a modem of the UE an attention (AT) command to configure the modem to send an unsolicited result code in response to receiving a pause command or a resume command related to sending of application level measurement information being gathered by the UE, receiving a pause command from a network element while sending of application level measurement information being gathered by the UE to the network element, sending from the modem to the application processor an unsolicited result code including a pause indication or instruction to temporarily pause sending of the application level measurement information in response to the received pause command and the AT command, and pausing sending of the application level measurement information by the modem in response to the pause command.

### BACKGROUND

In Long Term Evolution (LTE) Fifth Generation (5G) New Radio (NR) and other communication technologies enable wireless devices to communicate information at high data rates (e.g., in terms of Gigabits per second, etc.). Some communication systems utilize millimeter wave (mmWave) frequency bands to provide high bandwidth communication links. A key aspect of wireless communication networks includes monitoring and maintenance of wireless communication links and the devices using the networks, generally referred to as a radio access network (RAN).

### SUMMARY

Various aspects of the present disclosure include methods and devices configured to perform the methods for managing data measurement reporting, such as Quality of Experience (QoE) reports, using attention (AT) commands and result codes exchanged between a modem processor of user equipment (UE) and another processor of the UE such as an application processor.

Various aspects may include sending from an application processor of the UE to a modem of the UE an attention (AT) command to configure the modem to send an unsolicited result code in response to receiving a pause command or a resume command related to sending of application level measurement information being gathered by the UE, receiving a pause command from a network element while the UE is sending to the network element application level measurement information being gathered by the UE, sending from the modem to the application processor an unsolicited result code including a pause indication to temporarily pause sending of the application level measurement information in response to the received pause command and the AT command, and pausing sending of the application level measurement information by the modem in response to the pause command.

In some aspects, the unsolicited result code including the pause indication or instruction may include an indication or instruction to temporarily pause sending of at least a subset of all application level measurement information in response to the received pause command and the AT command. In some aspects, the unsolicited result code including the pause indication or instruction may include an indication or instruction to temporarily pause gathering of at least a subset of all application level measurement information in response to the received pause command and the AT command.

In some aspects, the unsolicited result code including the pause indication or instruction may include an indication of an application service instance providing the application level measurement information in accordance with information in an application measurement configuration file. In some aspects, the unsolicited result code including the pause indication or instruction further may include an indication of an application service type associated with the application service instance.

In some aspects, the unsolicited result code including the pause indication may include an indication to pause gathering of RAN Visible QoE (RVQoE) metrics as separate application level measurement information in response to the received pause command and the AT command. In some aspects, the unsolicited result code including the pause indication or instruction may include an indication of an application service instance associated with the RAN Visible QoE application level measurement information. In some aspects, the unsolicited result code including the pause indication may include an indication of an application service type with which the application service instance, associated with the RAN Visible QoE application level measurement information, is associated.

In some aspects, the AT command may include an indication of whether to enable a display by the UE of the unsolicited result code by the modem of the UE to the application processor of the UE. In some aspects, the unsolicited result code including the pause indication or instruction may include an indication or instruction to the application processor to continue to gather application level measurement information and to store gathered application level measurement information in an application layer memory according to configuration information in an application layer memory. In some aspects, the modem may include an access stratum of the UE and the application processor may include an application level of the UE.

Some aspects may include receiving a resume command from the network element while sending of application level measurement information from the UE to the network element is paused, sending from the modem to the application processor an unsolicited result code including a resume indication or instruction to resume sending application level measurement information in response to the received resume command and the AT command, and resuming sending application level measurement information by the modem in response to the resume command.

In some aspects, the unsolicited result code including the resume indication or instruction may include an indication for the application processor to resume a transfer of application level measurements to the modem, and resuming sending application level measurement information in response to the resume command may include resuming transfer of application level measurements by the application processor of the UE to the modem of the UE. In some aspects, the unsolicited result code including the resume indication or instruction may include an indication or instruction to resume sending of at least a subset of all application level measurement information in response to the received resume command and the AT command.

In some aspects, resuming sending of application level measurement information in response to the resume command may include transferring to the modem application level measurement information that is stored in application layer memory. In some aspects, the unsolicited result code including the resume indication may include an indication of an application service instance to resume sending application level measurement information. In some aspects, the unsolicited result code including the resume indication may further include an indication of an application service type associated with the application service instance. In some aspects, the unsolicited result code including the resume indication may include an indication to apply a new application level measurement configuration file of an application service providing the application level measurement information.

Further aspects may include a UE having a processor and a modem configured to perform one or more operations of any of the methods summarized above. Further aspects may include a non-transitory processor-readable storage medium having stored thereon processor-executable instructions configured to cause a processor and modem of a UE to perform operations of any of the methods summarized above. Further aspects include a UE having means for performing functions of any of the methods summarized above. Further aspects include a system on chip for use in a UE that includes a processor configured to perform one or more operations of any of the methods summarized above. Further aspects include a system in a package that includes two systems on chip for use in a UE that includes a processor and a modem configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a system block diagram illustrating an example communication system suitable for implementing any of the various embodiments.

FIG. 2 is a component block diagram illustrating an example computing and wireless modem system suitable for implementing any of the various embodiments.

FIG. 3 is a diagram illustrating an example of a software architecture including a radio protocol stack for the user and control planes in wireless communications in accordance with various embodiments.

FIG. 4A is a message flow diagram illustrating aspects of a method for managing data measurement reporting according to various embodiments.

FIGS. 4B and 4C are tables illustrating extended commands and possible responses.

FIGS. 4D, 4E, 4F, and 4G are tables illustrating commands and unsolicited result codes in accordance with various embodiments.

FIG. 4H is a table illustrating an action command to report measurements in accordance with various embodiments.

FIG. 5 is a process flow diagram illustrating a method that may be performed by a UE for managing data measurement reporting in accordance with various embodiments.

FIG. 6 is a process flow diagram illustrating operations that may be performed by a UE as part of the method for managing data measurement reporting in accordance with various embodiments.

FIG. 7 is a component block diagram of a UE suitable for use with various embodiments.

FIG. 8 is a component block diagram of a network computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments provide methods for managing gathering and reporting of performance measurements on a user equipment (UE) in response to network commends by using attention (AT) commands and responses exchanged between a modem processor of the UE and another processor (e.g., an application processor) of the UE over an AT interface. Various embodiments may include an application processor of the UE sending an AT command to a modem of the UE that configures the modem to send an unsolicited result code in response to receiving a pause command or a resume command related to gathering and sending of application-level measurement information to a network element. So configured by the AT command, when the modem receives a pause command from the network element during gathering and sending application level measurement information to the network element, the modem sends an unsolicited result code to the application processor. This unsolicited result code includes a pause indication to temporarily pause sending of the application level measurement information, which causes a pause in the transmission of application level measurement information. Also, the modem configured by the AT command will send the application processor an unsolicited result code in response to receiving a resume command from the network element, which causes a resumption in the transmission of application level measurement information.

The term “user equipment (UE)” is used herein to refer to any one or all of, terminal equipment, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., wireless gaming controllers, music and video players, satellite radios, etc.), wireless-network enabled Internet of Things (IoT) devices including smart meters/sensors, wireless router devices, wireless appliances, industrial manufacturing equipment, large and small machinery and appliances for home or enterprise use, computing devices within autonomous and semiautonomous vehicles, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single UE. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a UE and/or subscription on a UE. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

A key management task of a wireless communication network, generally referred to as a radio access network (RAN), involves monitoring and maintenance of wireless communication links and the devices that use the communication links. When communication links become congested or overloaded, the performance and/or efficiency of the communication network may be degraded. Communication networks use various performance information reported from UEs to monitor and adjust wireless communication links.

To obtain the information that the communication network uses for monitoring and adjusting wireless communication links, procedures exist by which a network element can task UEs to gather certain performance information, such as Quality of Experience (QoE) information, and transmit the gathered information back to the network element, such as in QoE reports. Occasionally, situations or conditions may arise in which the network element needs to temporary stop the gathering of performance information from a UE, such as to temporarily free up wireless bandwidth. As currently configured, network elements can only start and stop the processes of gathering of performance information from UEs, which can lead to inefficiencies associated with stopping and restarting such performance measurement and reporting processes when only a brief pause is required.

Various embodiments enable a UE to temporarily pause sending of application level measurement information (e.g., QoE reports) by the UE to a network element of the communication network. For example, to address or mitigate a RAN overload condition, the UE may receive a command from the network element to temporarily pause reporting application level measurement information to the communication network. Various embodiments further enable a UE to resume sending application level measurement information to the communication network in response to a resume command from the network element, such as may be sent when an overload condition has abated or ended.

In various embodiments, the UE may perform internal configuration operations to enable the UE to receive and appropriately handle a pause command or a resume command from a network element of a communication network. In particular, an application processor (or another suitable device of an application layer of the UE) of the UE may send to a modem of the UE (i.e., to a modem processor or another suitable device of an access stratum (AS) of the UE) an AT command that configures the modem to send an unsolicited result code in response to receiving a pause command or a resume command related to sending of application level measurement information gathered by the UE. In some embodiments, the AT command and an associated unsolicited result code may be represented by a +C syntax for commands and result codes such as “+CAPPLEVMR”, “+CAPPLEVMC”, “+CAPPLEVMRNR”, or “+CAPPLEVMCNR” together with additional extensions, arguments, or parameters, as further described below.

In various embodiments, such pause and resume commands may be received from a network element, which may be a network element configured to perform Operations, Administration and Maintenance (OAM) operations, a network element configured to perform trace collection entity (TCE) or measurement collection entity (MCE) operations, a network element of the RAN, and/or another network element. While sending application level measurement information being gathered by the UE (i.e., to the communication network), the UE may receive a pause command from the network element.

In response to receiving a pause command, the modem may pause sending of the application level measurement information to the network element. Additionally, in response to the received pause command and the AT command (i.e., in response to being previously configured through receipt of the AT command), the modem of the UE may send to the application processor of the UE an unsolicited result code in accordance with the configurations specified in the AT command. In some embodiments, the unsolicited result code may include a pause indication to temporarily pause sending of the application level measurement information by the application processor. In some embodiments, the application level measurement information associated with the unsolicited result code may pertain to RAN Visible QoE metrics measurement information. In some embodiments, the unsolicited result code may include a pause indication or instruction to temporarily pause the sending of all application level measurement information by the application processor, a subset of application level measurement information corresponding to RAN-specific Visible QoE metrics measurement information, or a subset of application level measurement information not corresponding to RAN-specific Visible QoE metrics measurement information. In some embodiments, the AT command may include an indication of whether to enable presentation of the unsolicited result code (such as sending a notification from the modem of the UE to the application processor of the UE). In some embodiments, the indication of whether to enable presentation of the unsolicited result code may include syntax such as <n> together with an integer indicating whether to allow (or enable) sending of the unsolicited result code (e.g., “0”) or to disallow (or disable) sending of the unsolicited result code (e.g., “1”). In some embodiments, the unsolicited result code command may be an AT “set command,” which may enable or disable the presentation of an unsolicited result code. In some embodiments, the unsolicited result code also may include an indication to pause gathering of application level measurement information, e.g., by the application processor. In some embodiments, the unsolicited result code also may include an indication of a pause in gathering of RAN-specific Visible QoE metrics measurement information.

In some embodiments, the unsolicited result code sent by the modem to the application processor in response to receiving a pause command may include an indication of an application service instance that is providing application level measurement information that is being paused. In some embodiments, the unsolicited result code may include an indication of an application service instance that is providing application level measurement information in accordance with information in an application measurement configuration file. In some embodiments, additionally or alternatively, the unsolicited result code also may include an indication of an application service type to which the application service instance belongs. The indication of the application service may include, for example, an indication of a streaming service, a Multimedia Telephony Service for IMS (MTSI), a Multimedia Broadcast Multicast Service (MBMS), a virtual reality (VR) service (which may include augmented reality (AR), mixed reality (MR), extended reality (XR), etc.), and/or another suitable service. An example of an application service instance is a specific streaming application that supports any of a number of different media streams (e.g., YouTube, Netflix, Disney+), each of which may configured as a “streaming” application service type. Each application service type may include one or more application service instances. In some embodiments, the indication of the application service may include a parameter such as <app-meas_service_type> together with an integer indication of the application service. In some embodiments, the unsolicited result code may include a flag, such as a value indicating to pause or resume application level measurement reporting for all configurations, applications, and/or services. In some embodiments, the unsolicited result code may include a value such as a Reference ID to indicate or distinguish one or more application level reporting configurations of a same service type. Some embodiments may include two types of configuration data, for example, <app-meas_config-file> and <RVQoE Config>. In such embodiments, a pause command or a resume command may be sent for, or may apply to, one or both types of application level information.

In some embodiments, the unsolicited result code that includes the pause indication also may indicate that the application processor should continue to gather application level measurement information and store the gathered application level measurement information in one of an application layer memory or an access stratum memory (e.g., memory of the UE modem). In some embodiments, the unsolicited result code that includes the pause indication also may indicate that the application processor should store application level measurement information in a memory (e.g., application layer memory) until such memory becomes full, at which point the application processor may discontinue performing application level measurements. In some embodiments, the unsolicited result code that includes the pause indication also may indicate that the application processor should pause both performing application level measurements and sending application level measurement information to the modem.

In some embodiments, the unsolicited result code that includes the pause indication may include a parameter such as <pause-resume_reporting)> that may indicate the temporary pause (or resumption) of application level measurement reporting for the application (or service) indicated by <app-meas_service_type>. In some embodiments, the parameter <pause-resume_reporting)> may include an indication (e.g., “0”) indicating that the application processor should resume transferring application level measurement information to the modem, including application level measurement information stored in memory (e.g., application level memory). In some embodiments, the parameter <pause-resume_reporting)> may include an indication (e.g., “1”) indicating that the application processor should pause both the application level measurement information transfer to the modem and application level measurement procedures. In some embodiments, the indication “1” or other suitable indication also may indicate that the application level measurement information should be stored in an access stratum memory.

In some embodiments, the parameter <pause-resume_reporting)> may include an indication (e.g., “2”) indicating that the application processor should pause the application level measurement data transfer to the modem, continue performing application level measurements, and store application level measurement information until allocated application layer memory becomes full, and then discontinue performing further application level measurements.

In some embodiments, the “+CAPPLEVMC” code (or “+CAPPLEVMCNR”, “+CAPPLEVMRNR”, or another suitable code) may include both a <start-stop_reporting> parameter and a <pause-resume_reporting> parameter. In some embodiments, the inclusion of both the <start-stop_reporting> parameter and the <pause-resume_reporting> parameter with “+CAPPLEVMC” (or “+CAPPLEVMCNR” or “+CAPPLEVMRNR”) may indicate that the application processor should perform operation(s) indicated by a value of the <pause-resume reporting> parameter (e.g., “0,” “1,” or “2”) as described above.

In some embodiments, the unsolicited result code that includes the pause indication also may include an application level measurement configuration file for each of one or more applications (or application level services). In some embodiments, the application level measurement configuration file may be represented as a string of octets, or another suitable representation. In some embodiments, the unsolicited result code that includes the pause indication may include a parameter, such as <app-meas_config-file>, that may include the application level measurement configuration file for the application (or application level service). In some embodiments, the unsolicited result code that includes the pause indication also may include a parameter, such as <config-id> to identify the configuration file associated with <app-meas_config-file>. In some embodiments, the unsolicited result code that includes the pause indication also may include a parameter, such as <app-meas_config_file_length>, that may indicate a number of octets (or another data grouping or arrangement) of the application level measurement configuration file (e.g., <app-meas_config-file>).

In some embodiments, the unsolicited result code that includes the pause indication also may include an indication to apply a new application level measurement configuration file of the application service providing the application level measurement information. For example, as noted above, the parameter <pause-resume_reporting)> may include an indication (e.g., “0”) indicating that the application processor should resume transferring application level measurement information to the modem. In some embodiments, when <pause-resume_reporting>=‘0’ is present in the unsolicited result code, the additional presence of optional fields such as <app-meas_config_file_length>, <app-meas_config-file>, and/or the like may signify to the application processor that a new application level measurement configuration file is to be applied at the time of resumption of application level measurement reporting. In some embodiments, default semantics (e.g., <pause-resume_reporting>=“0” and the <app-meas_config_file_length> and <app-meas_config-file> fields are absent) may signify to the application processor that a configuration file used prior to the pause indication remains valid upon the resumption of measurement reporting.

In some embodiments, the unsolicited result code may include a parameter indicating application level measurement information that represents RAN-specific and visible attributes. In some embodiments, such parameter may be represented as <RVQoE Config>, indicating RAN Visible QoE configuration parameters. In some embodiments, the reporting configuration attributes may include one or more metrics to measure as part of the application level measurement information (e.g., buffer level, play list, play out delay, and other suitable attributes), a qualitative or numeric score for application level measurement information (e.g., a QoE score), a periodicity for reporting the application level measurement information, a reporting or event trigger, and/or other suitable configuration information. In some embodiments, the unsolicited result code may include a parameter that separately indicates metrics to be reported in the application level measurement information. In some embodiments, such a parameter may be represented as <RVQoE Report>, indicating RAN Visible QoE reporting parameters.

After a pause command has been received (e.g., while sending of the application level measurement information from the UE to the network element is paused), the UE may receive a resume command from the network element commanding the UE to resume sending application level measurement information to the communication network. In some embodiments, in response to the received resume command and the previously received AT command (i.e., the AT command that configured the modem to send an unsolicited result code in response to receiving a pause command or a resume command), the modem may send to the application processor an unsolicited result code that includes a resume indication that the application processor should resume sending application level measurement information. The UE may then resume sending application level measurement information by the modem in response to the resume command.

In some embodiments, the unsolicited result code including the resume indication may include an indication that the application processor should resume a transfer of application level measurements to the modem. In some embodiments, the application processor may transfer to the modem application level measurement information that was stored in memory (e.g., an application level memory). In some embodiments, the resume indication may include an indication that the application processor should resume sending application level measurement information. In some embodiments, the resume indication may include an indication of a streaming service, a MTSI service, an MBMS service, a VR service, and/or another suitable service that should resume sending application level measurement information. In some embodiments, the resume indication may include an indication of an application service instance that should resume sending application level measurement information. In some embodiments, the resume indication may include an indication of an application service type associated with one or more application service instances. In some embodiments, the unsolicited result code that includes the resume indication may include an indication to apply a new application level measurement configuration file of the application service providing the application level measurement information.

Various embodiments may improve the operation of a UE and the communication network by enabling the UE to pause and resume reporting application level measurement information to the communication network, which can alleviate a RAN overload condition such as network device congestion or communication link congestion. Various embodiments may improve the efficiency and performance of the UE and the communication network by continuing to perform application level measurements and store the application level measurement information while reporting is paused, and then provide the application level measurement information when reporting is resumed, which may provide the communication network with more performance information about the RAN than would be the case if reporting of application level measurement information were to be stopped or terminated.

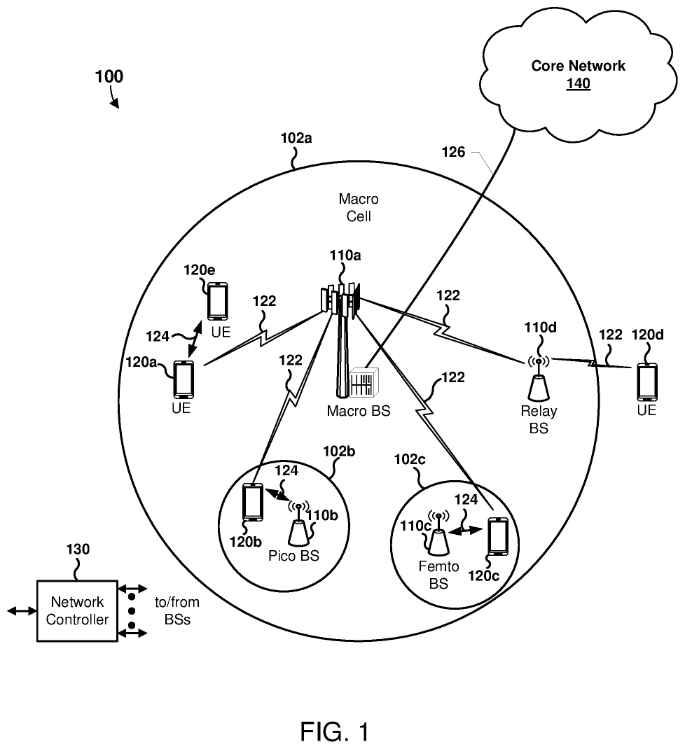

FIG. 1 is a system block diagram illustrating an example communication system 100 suitable for implementing any of the various embodiments. The communications system 100 may be a Fifth Generation (5G) New Radio (NR) network, or any other suitable network such as an LTE network, 5G network, etc. While FIG. 1 illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of mobile devices (illustrated as UEs 120a-120e). The communications system 100 also may include a number of base stations (illustrated as BSs 110a, 110b, 110c, and 110d) and other network entities. A base station is an entity that communicates with UEs, and also may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used. The core network 140 may be any type core network, such as an LTE core network (e.g., an evolved packet core (EPC) network), 5G core network, etc.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with a service subscription. A femto cell may cover a relatively small geographic area (for example, a home) and may allow restricted access by UEs having an association with the femto cell (for example, UEs in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1A, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network. The base stations 110a-110d may communicate with the core network 140 over a wired or wireless communication link 126. The UE 120a-120e may communicate with the base station 110a-110d over a wireless communication link 122.

The wired communication link 126 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (e.g., relay BS 110d). A relay station is an entity that can receive a transmission of data from an upstream station (for example, a base station or a UE) and send a transmission of the data to a downstream station (for example, a UE or a base station). A relay station also may be a UE that can relay transmissions for other UEs. In the example illustrated in FIG. 1A, a relay station 110d may communicate with macro the base station 110a and the UE 120d in order to facilitate communication between the base station 110a and the UE 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The UE 120a-120e may be dispersed throughout communications system 100, and each UE may be stationary or mobile. A UE also may be referred to as an access terminal, a wireless device, a terminal, a mobile station, a subscriber unit, a station, etc.

A macro base station 110a may communicate with the communication network 140 over a wired or wireless communication link 126. The UEs 120a-120d may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio Access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some embodiments may use terminology and examples associated with LTE technologies, various embodiments may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 ms duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL Control data. Beamforming may be supported and beam direction may be dynamically configured. Multiple Input Multiple Output (MIMO) transmissions with precoding may also be supported. MIMO configurations in the DL may support up to eight transmit antennas with multi-layer DL transmissions up to eight streams and up to two streams per UE. Multi-layer transmissions with up to 2 streams per UE may be supported. Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. The UE 120a-120e may be included inside a housing that houses components of the UE, such as processor components, memory components, similar components, or a combination thereof.

In general, any number of communications systems and any number of wireless networks may be deployed in a given geographic area. Each communications system and wireless network may support a particular radio Access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some implementations, two or more UEs 120a-120e (for example, illustrated as the UE 120a and the UE 120e) may communicate directly using one or more sidelink channels 124 (for example, without using a base station 110a-110d as an intermediary to communicate with one another). For example, the UEs 120a-120e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the UE 120a-120e may perform scheduling operations, resource selection operations, as well as other operations described elsewhere herein as being performed by the base station 110a-110d.

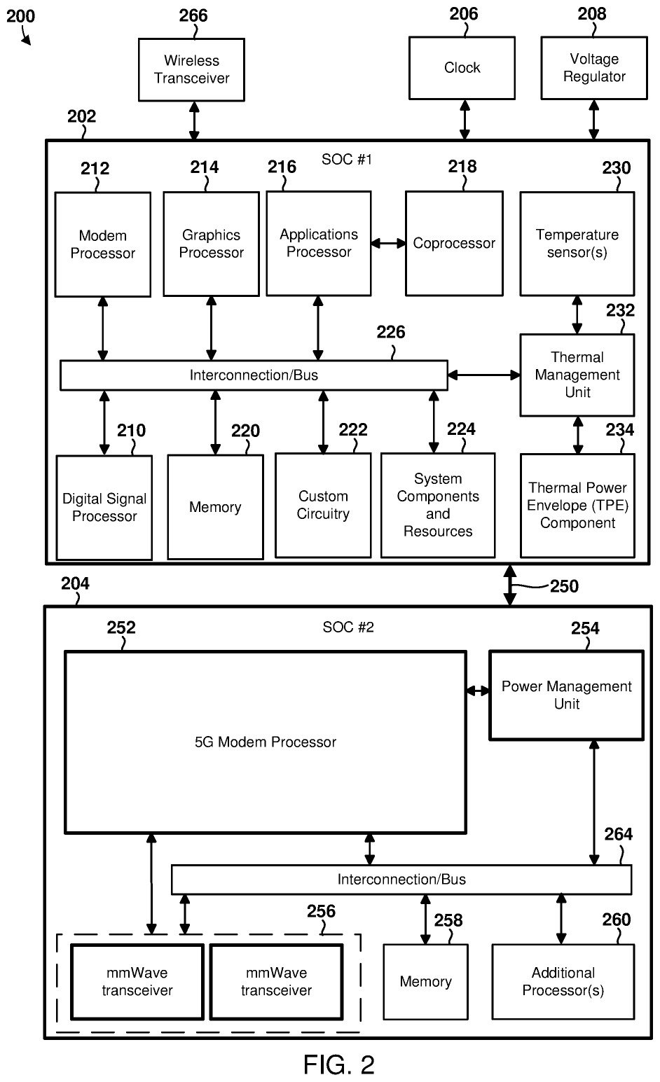

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1 and 2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a UE (e.g., 120a-120e) or a base station (e.g., 110a-110d). In some embodiments, the first SOC 202 may operate as central processing unit (CPU) of the UE that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wave length (e.g., 28 GHz mmWave spectrum, etc.) communications.

The first SOC 202 may include a digital signal processor (DSP) 210, a modem processor 212, a graphics processor 214, an application processor (AP) 216, one or more coprocessors 218 (e.g., vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, the plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a UE. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs). The interconnection/bus modules 226, 250, 264, individually and/or in various combinations, may be configured as AT interfaces to enable the processors 210, 212, 214, 216, 218, 252, 260 to exchange AT commands and/or responses with one another.

The first and/or second SOCs 202, 204 may further include an input/output module (not illustrated) for communicating with resources external to the SOC, such as a clock 206, a voltage regulator 208, and one or more wireless transceivers 266. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

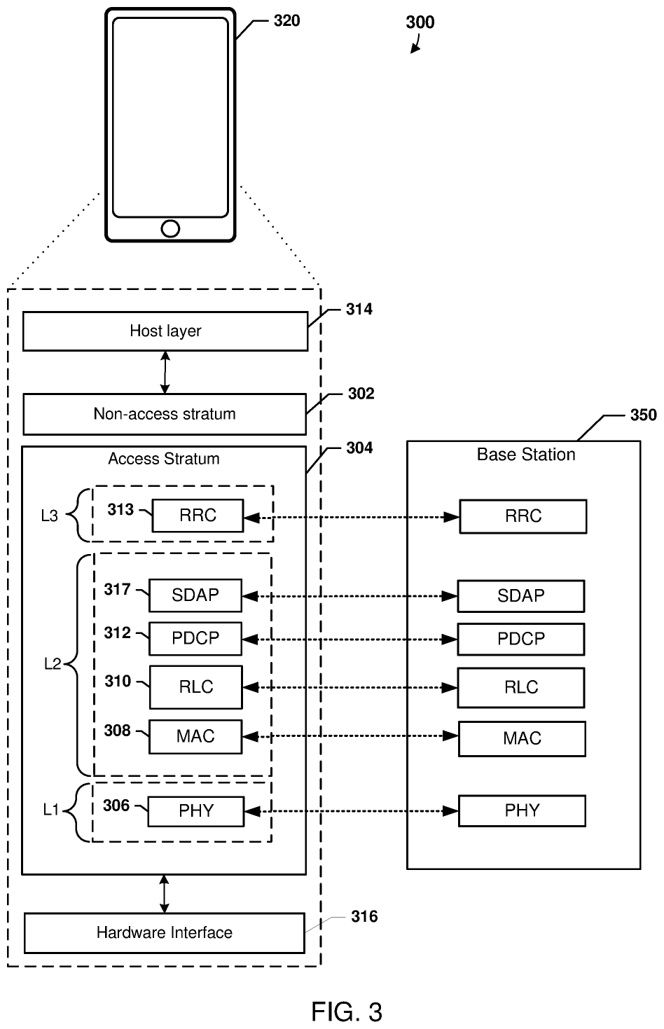

FIG. 3 is a component block diagram illustrating a software architecture 300 including a radio protocol stack, also referred to as a wireless protocol stack, for the user and control planes in wireless communications suitable for implementing any of the various embodiments. With reference to FIGS. 1-3, the UE 320 may implement the software architecture 300 to facilitate communication between a UE 320 (e.g., the UE 120a-120e, 200) and the base station 350 (e.g., the base stations 110a-110d) of a communication system (e.g., 100). In some embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack (or one wireless protocol stack), in a multi-SIM (subscriber identity module) UE, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support Packet filtering, security management, mobility control, session management, and traffic and signaling between a SIM(s) of the UE and its core network 140. The AS 304 may include functions and protocols that support communication between a SIM(s) and entities of supported access networks (e.g., a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer 306 may include various logical channels, including the Physical Downlink Control Channel (PDCCH) and the Physical Downlink Shared Channel (PDSCH). As an example, the PHY layer 306 may support Channel State Information (CSI) measurements and reporting (e.g., Channel Quality Indicator (CQI) measurements and reporting).

In the user and control planes, Layer 2 (L2) of the AS 304 may be responsible for the link between the UE 320 and the base station 350 over the physical layer 306. In the various embodiments, Layer 2 may include a Media Access Control (MAC) sublayer 308, a Radio Link Control (RLC) sublayer 310, a Packet Data Convergence Protocol (PDCP) 312 sublayer, and a Service Data Adaptation Protocol (SDAP) 317 sublayer, each of which form logical connections terminating at the base station 350.

In the control plane, Layer 3 (L3) of the AS 304 may include a Radio Resource Control (RRC) sublayer 3. While not shown, the software architecture 300 may include additional Layer 3 sublayers, as well as various upper layers above Layer 3. In various embodiments, the RRC sublayer 313 may provide functions including broadcasting system information, paging, and establishing and releasing an RRC signaling connection between the UE 320 and the base station 350.

In various embodiments, the SDAP sublayer 317 may provide mapping between Quality of Service (QoS) flows and data radio bearers (DRBs). In various embodiments, the PDCP sublayer 312 may provide uplink functions including multiplexing between different Radio bearers and logical channels, sequence number addition, handover data handling, integrity protection, ciphering, and header compression. In the downlink, the PDCP sublayer 312 may provide functions that include in-sequence delivery of data packets, duplicate data Packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the UE 320. In some embodiments, application-specific functions provided by the at least one host layer 314 may provide an interface between the software architecture and the general purpose processor.

In other embodiments, the software architecture 300 may include one or more higher logical layer (e.g., transport, session, presentation, application, etc.) that provide host layer functions. In some embodiments, the software architecture 300 may include an application layer in which a logical connection terminates at another device (e.g., end user device, server, etc.). In some embodiments, the software architecture 300 may further include in the AS 304 a hardware interface 316 between the physical layer 306 and the communication hardware (e.g., one or more radio frequency (RF) transceivers).

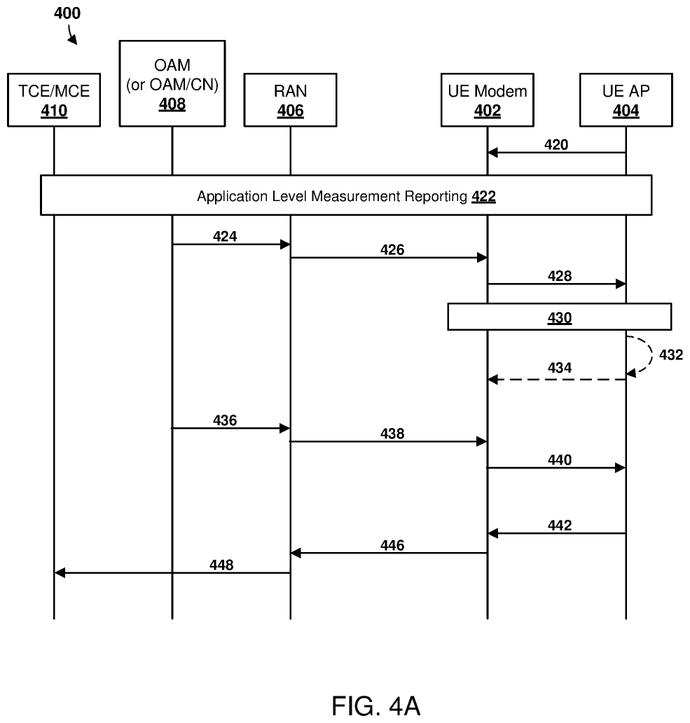

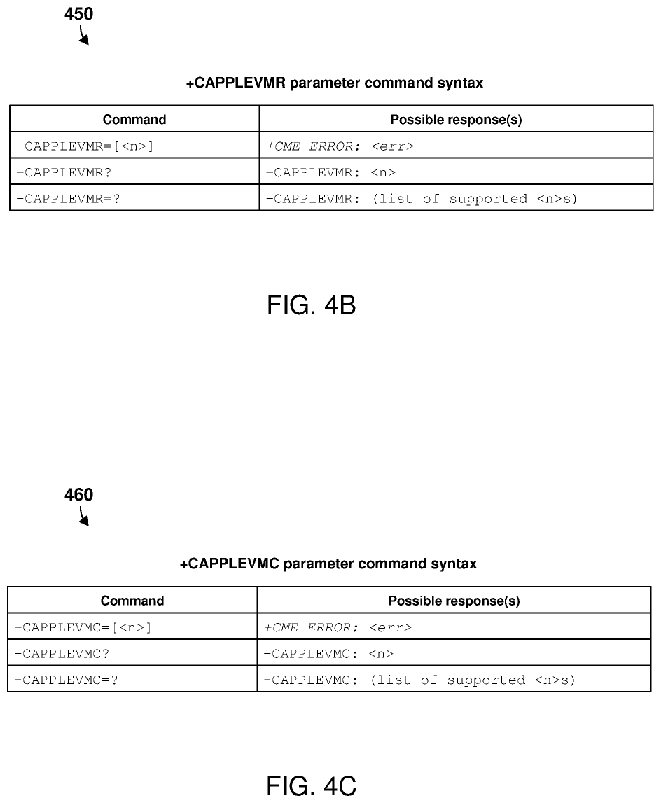

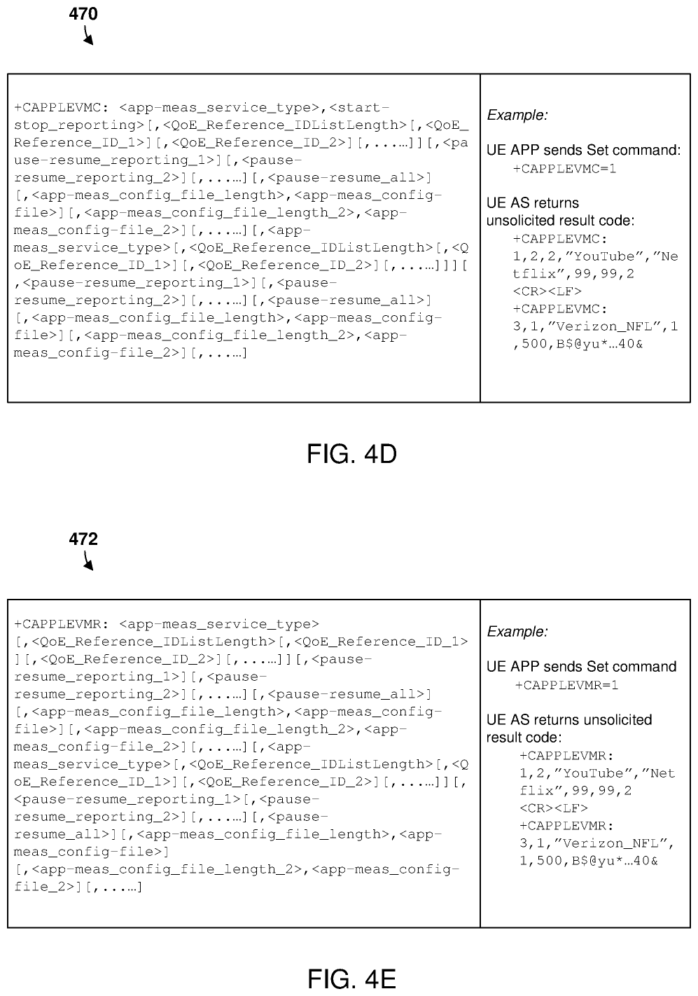

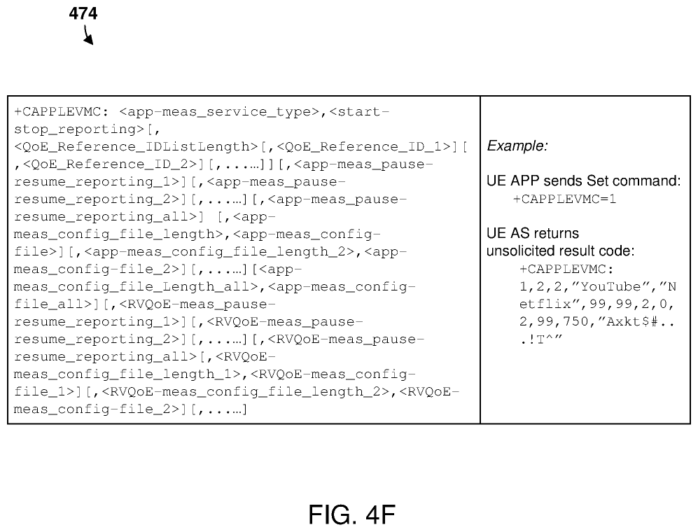

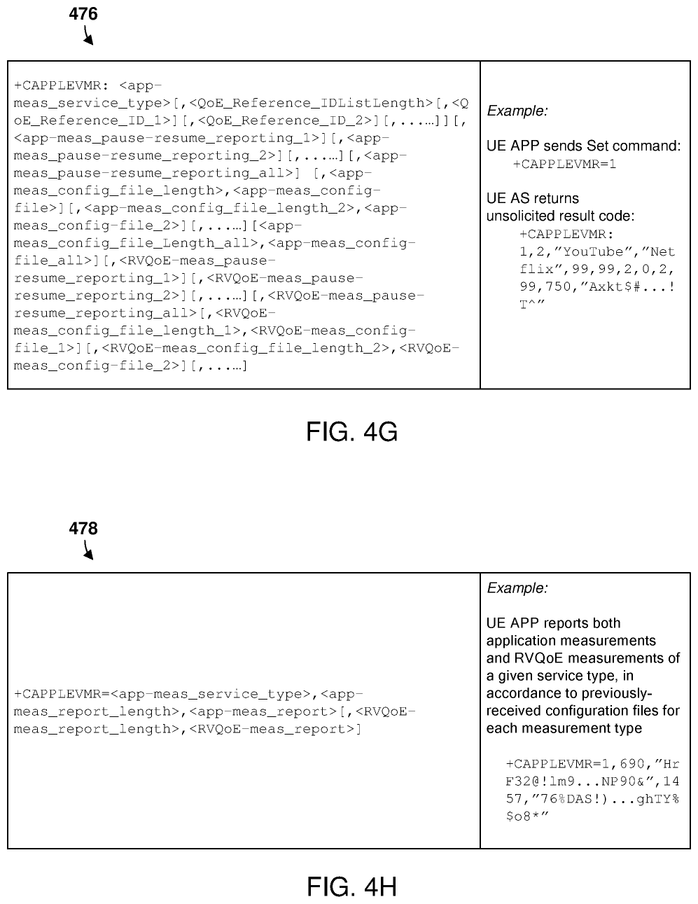

FIG. 4A is a message flow diagram illustrating aspects of a method 400 for managing data measurement reporting according to various embodiments. FIGS. 4B and 4C are tables illustrating extended commands 450 and 460 and possible responses. FIGS. 4D, 4E, 4F, and 4G are tables illustrating commands and unsolicited result codes 470, 472, 474, and 476 in accordance with various embodiments. FIG. 4H is a table illustrating a command to report measurements 478 in accordance with various embodiments. With reference to FIGS. 1-4E, various operations of the method 400 may be performed by a modem 402 of a UE (e.g., in a UE access stratum), an application processor (AP) 404 of the UE (e.g., in a UE application layer), a network element of a radio access network (e.g., RAN 406), a network element configured to perform OAM operations (e.g., OAM 408), and a network element configured to perform Trace Collection Entity (TCE) operations or Multi-cell/Multicast Coordination Entity (MCW) operations (e.g., TCE/MCE 410).

The application processor 404 may send to the modem 402 an AT command 420 to configure the modem 402 receive and response appropriately to a pause command or a resume command from a communication network element, such as the OAM 408. In some embodiments, the AT command 420 may configure the modem 402 to send an unsolicited result code in response to receiving a pause command or a resume command related to sending of application level measurement information being gathered by the UE (e.g. by the application processor 404). In some embodiments, the AT command 420 may include a +C syntax command such as “+CAPPLEVMR”, “+CAPPLEVMCNR”, “+CAPPLEVMRNR”, or “+CAPPLEVMC,” and may include additional extensions, arguments, or parameters.

For example, the AT command 420 may include a +CAPPLEVMR command 450 (FIG. 4B). As another example, the AT command 420 may include a +CAPPLEVMC command 470 (FIG. 4C). Various embodiments further may include a +CAPPLEVMCNR command. In various embodiments, the AT command 420 may enable the modem 402 to present an unsolicited result code (e.g., +CAPPLEVMR, +CAPPLEVMCNR, +CAPPLEVMRNR, or +CAPPLEVMC) that may include various parameters, for example, as <app-meas_service_type>, <pause-resume_reporting>, <appmeas_config_file_length>, <app-meas_config-file>. In some embodiments, the various parameters may correspond to a command from a communication network element, such as a pause command or a resume command, instructing the UE to pause or resume application level measurement reporting. In some embodiments, an unsolicited result code may include an integer type <n> indicating, for example, whether to disable presentation of the unsolicited result code (e.g., “0”) or to enable presentation of the unsolicited result code (e.g., “1”) by the modem of the UE to the application processor of the UE. In some embodiments, the unsolicited result code may include an indication of an application or application service that is a target for the application level measurement configuration. In some embodiments, the indication of the application or service may be represented by a value of a <app-meas_service_type> parameter. Examples of an application or service include a streaming service, an MTSI service, and MBMS service, a VR service, or another suitable service or application.

In some embodiments, the unsolicited result code may include a parameter (e.g., <pause-resume_reporting>) that indicates one or more additional operations to the application processor 404. For example, the unsolicited result code may include a value for <pause-resume_reporting> of “0” indicating to the application processor 404 to resume application level measurement data transfer to the modem 402 (e.g., to the access stratum, including the transfer of any data stored in application (APP) layer memory (e.g., an APP layer buffer) during the pause. As another example, the unsolicited result code may include a value for <pause-resume_reporting> of “1” indicating to the application processor 404 to pause the application level measurement information transfer to the modem 402 and to pause performing measurement operations. As another example, the unsolicited result code may include a value for <pause-resume_reporting> of “2” indicating to the application processor 404 to pause the application level measurement data transfer to the modem 402, and to continue the recording of application level measurements until the allocated application layer memory becomes full, and then discontinue further measurement. In some embodiments, a value for <pause-resume_reporting> of “2” may indicate to or instruct the application processor to store the application level measurement information in application layer memory.

In some embodiments, a value for <pause-resume_reporting> of “1” may indicate to or instruct the application processor to store the application level measurement information, or to send the application level measurement information to the modem 402 for storage, in access stratum memory. In some embodiments, a value for <pause-resume_reporting> of “1” may indicate that the modem may store application level measurement information in access stratum memory, and as long as access stratum memory is available the modem may withhold sending the unsolicited result code to the application processor. In response to determining that the access stratum memory is full (and, in some cases, in the absence of a resume command from the network), the modem may send the unsolicited result code including the value for <pause-resume_reporting> of “1,” to indicate to or instruct the application processor to pause performing the application level measurements, and to pause sending the application level measurement information to the modem.

In some embodiments, the unsolicited result code may include a parameter that includes an application level measurement configuration file for the application or service indicated by the <app-meas_service_type> parameter. In some embodiments, the application level measurement configuration file may be represented by a string of one or more octets. In such embodiments, the unsolicited result code may include a parameter, which may be represented by <app-meas_config_file_length>, that indicates a number of octets of the configuration file. In some embodiments, when the value of the <pause-resume_reporting> parameter is “0”, the additional presence of the such parameters as <app-meas_config_file_length> and app-meas_config-file> may indicate to or instruct the application processor 404 that a new application level measurement configuration file is to be applied at the time of resumption of the application level measurement reporting. In some embodiments, when the value of the <pause-resume_reporting> parameter is “0,” the absence of the <app-meas_config_file_length> and <app-meas_config-file> parameters may indicate to or instruct the application processor 404 that a configuration file used prior to the pause command (i.e., a currently-used configuration file) remains valid when resuming reporting of application level measurement information.

The modem 402 may perform operations 422 for application level measurement reporting. Such operations 422 may include receiving an activation message from the OAM 408, exchanging RRC signaling between the RAN 406 and the modem 402, and from time to time application level measurement reporting by the modem 402 to the TCE/MCE 410. In some embodiments, the operations 422 also may include the modem 402 sending to the RAN 406 an indication of one or more capabilities of the UE related to application level measurement reporting.

The OAM 408 may send a pause command 424 to the RAN 406. The RAN 406 may send a message 426 including or indicating the pause command to the modem 402. In some embodiments, the message 426 may be or may be included in RRC signaling to the modem 402. In some embodiments, the OAM 408 may send the pause command 424 to the RAN 406 as part of a Management-based QoE activation procedure. In some embodiments, in a Signaling-based QoE activation procedure, the OAM 408 may send a QoE measurement configuration message to a network element of a core network (CN), and the network element of the core network may send the pause command 424 to the RAN 406.

In response to the received pause command in the message 426 and the AT command 420, the modem 402 may send an unsolicited result code 428 to the application processor 404. In some embodiments, the unsolicited result code 428 may include a pause indication that indicates to the application processor to temporarily pause sending of all application level measurement information. In some embodiments, the unsolicited result code 428 also may include an indication or instruction to pause the collection of all application level measurement information by the application processor. In some embodiments, the unsolicited result code 428 may include an indication or instruction to temporarily pause sending RAN Visible QoE application level measurement information. In some embodiments, the unsolicited result code 428 may include a pause indication or instruction to temporarily pause both the sending of the application level measurement information and the collection of the application level measurement information by the application processor. In some embodiments, the unsolicited result code 428 may include a +C syntax such as “+CAPPLEVMR,” “CAPPLEVMCNR,” or “+CAPPLEVMC,” and may include additional extensions, arguments, or parameters, such as one or more of those extensions or parameters as described above.

The modem 402 and the application processor 404 may perform operations 432 to pause sending of the application level measurement information and which may also pause the application level measurement procedure. In some embodiments, based on an extension or parameter of the unsolicited result code 428, the application processor 404 may perform optional operations 432 to continue to gather application level measurement information and store the gathered application level measurement information according to configuration information in memory. In some embodiments, the application processor 404 may store the gathered application level measurement information in an application layer memory. In some embodiments, the application processor 404 may perform optional operations 434 to store the gathered application level measurement information in an access stratum memory, or to send the gathered application level measurement information to the modem 402 for storage in the access stratum memory.

The OAM 408 may send a resume command 436 to the RAN 406. The RAN 406 may send a message 438 including or indicating the resume command to the modem 402. In some embodiments, the message 436 may be included in RRC signaling to the modem 402. In some embodiments, the OAM 408 may send the resume command 436 to the RAN 406 as part of a Management-based QoE deactivation procedure. In some embodiments, in a Signaling-based QoE deactivation procedure, the OAM 408 may send a QoE deactivation configuration message to a network element of the core network (CN), and the network element of the core network may send the resume command 424 to the RAN 406.

In response to the received resume command in the message 438 and the AT command 420, the modem 402 may send an unsolicited result code 440 to the application processor 404. In some embodiments, the unsolicited result code 440 may include a resume indication that indicates to or instructs the application processor to resume sending of all application level measurement information. In some embodiments, the unsolicited result code 440 also may include an indication or instruction to resume the collection of all application level measurement information if such measurements were paused. In some embodiments, the unsolicited result code 440 may include a resume indication that indicates to or instructs the application processor to resume the sending of a subset of the application level measurement information, for example, strictly the RAN Visible QoE application level measurement information. In some embodiments, the unsolicited result code 440 may include a +C syntax such as “+CAPPLEVMR,” “CAPPLEVMCNR,” or “+CAPPLEVMC,” and may include additional extensions, arguments, or parameters, such as one or more of those extensions or parameters as described above.

In response to the resume indication, the application processor 404 may send an AT command 442 to the modem 402 that includes application level measurement information. In some embodiments, the application level measurement information may include a QoE report.

The modem 402 may send the application level measurement information to the RAN 406 in a message 446. In some embodiments, the message 446 may be or may be included in RRC signaling to the RAN 406.

The RAN 406 may send the application level measurement information to the TCE/MCE 410 in a message 448.

With reference to FIGS. 4D and 4E, in some embodiments, the application processor (UE APP) may send an AT command (e.g., a Set command) such as +CAPPLEVMC=1, or +CAPPLEVMCNR=1, or +CAPPLEVMR=1, to the modem (UE AS). In some embodiments, the modem may respond with an unsolicited result code 470 or 472. The unsolicited result code 470 or 472 may include a +CAPPLEVMC, or +CAPPLEVMCNR, or +CAPPLEVMR code that includes a variety of extensions, arguments, or parameters. Brackets indicate parameters that may be optionally included in the unsolicited result codes 470 and 472 in some embodiments. In some embodiments, the unsolicited result code 470 and/or 472 may be enhanced to include one or more of a list of application-specific Quality of Experience (QoE) configurations, associated with a single service type or multiple service types, to which a pause command or a resume command may apply (e.g., rather than just one service type-specific QoE configuration), a flag (or other indication) to pause or resume QoE measurement reporting for all QoE configurations, and/or a QoE Reference ID, to distinguish multiple QoE configurations for a type of application service. In some embodiments, a number of entries in the list of application-specific QoE configurations may include entries up to a specified number N (e.g., N=64). In some embodiments, if all active applications on the UE belong to a single service, then QoE_Reference_ID might be present in the unsolicited result code. In some embodiments, if at least one active application on the UE belong to different service types, presence of <meas_config_app_layer_id> without <QoE_Reference_ID> would suffice (and may be preferred to be efficient). Other possible parameters may include <meas_config_app_layer_id>, <start-stop_measurement>, <ran_visible_release_only>, <app-meas_config_file_length>, <app-meas_config-file>, <transmission_of_session_start-end>, <ran_visible_periodicity>, <number_of_buffer_level_entries>, <report_initial_playout_delay>, and <app-meas_service_type>.

In some embodiments, the extensions to the unsolicited result codes 470 and 472 may enable identification of individual application service instances to which a pause command or a resume command of application level measurement reporting applies. In some embodiments, the parameters or extensions may include a configuration or list of configurations. For example, the parameter <QoE_Reference_IDListLength> may include a list of application-specific QoE configurations, which may be associated with one or more service types, to which a pause or resume command may apply. In some embodiments, the parameters or extensions may include a flag or other indication, such as <pause-resume_all>, to pause or resume QoE measurement reporting for all QoE configurations. Another flag may indicate that QoE measurement reporting for one, or for some, applications or QoE configurations should be paused or resumed. In some embodiments, the parameters or extensions may include a reference ID to distinguish among configurations of QoE measurement reporting configurations of the same service type (e.g., <QoE_Reference_ID_1>, <QoE_Reference_ID_2>, etc.).

For example, referring to FIG. 4D, the unsolicited result codes 470 and 472 may provide information for two application services. For the first application service, the parameter <app-meas_service_type>=1 may indicate that a streaming service is a target for QoE measurements (e.g., “QoE measurement collection for VR services’). As other examples, <app-meas_service_type>=2 may indicate “QoE measurement collection for MTSI services,” and, <app-meas_service_type>=3 may indicate “QoE measurement collection for VR services.” The parameter <start-stop_reporting>=2 may indicate that this function is overridden by pause/resume signaling. The parameter <QoE_Reference_IDListLength>=2 may denote two entries in the list, e.g., “YouTube” and “Netflix.” The parameters <pause-resume_reporting_1> and <pause-resume_reporting_2> in this example are set to ‘99’ to indicate that the parameters are overridden by <pause-resume_all>, which is set to 2 (which, in some embodiments, may be assumed to have same meaning as <pause-resume_reporting>=2). Some embodiments may not include such parameters as <app-meas_config_file_length> and <app-meas_config-file> for either service. The parameter <app-meas_config-file> may include an application level measurement configuration file for the application indicated by the <app-meas_service_type> parameter. In some embodiments, the <app-meas_config-file> may not be subject to conventional character conversion as per +CSCS. The parameter <app-meas_config_file_length> may indicate a number of octets of the <app-meas_config-file> parameter.

For the second service, the parameter <app-meas_service_type>=3 may indicate an MBMS service for QoE measurements. In some embodiments, for the second service, the <start-stop_reporting> parameter may be redundant. The parameter <QoE_Reference_IDListLength>=1 may denote a single entry in the list, such as “Verizon_NFL.” The parameter <pause-resume_reporting_1>=1 may indicate to or instruct the application processor to pause performing measurements or gathering of the application level measurement information for this application service type, and to pause sending the application level measurement information to the modem. The parameter <app-meas_config_file_length_1> may indicate a length, such as 500 bytes. The parameter <app-meas_config-file_1> may include information such as a string of ASCII-encoded characters, which in some embodiments may include 500 bytes of information, corresponding to the <app-meas_config_file_length_1> parameter.

In some embodiments, the extensions to the unsolicited result codes 470 and 472 may include a variety of other possible parameters. A parameter <transmission_of_session_start-end> may include an indication of whether a session start-end is required (e.g., 0=Not required, or 1=Required.) A parameter <ran_visible_periodicity> may indicate a periodicity with a value such as “0” indicating 120 ms, “1” indicating 240 ms, “2” indicating 480 ms, “3” indicating 640 ms, or “4” indicating 1024 ms. A parameter <number_of_buffer_level_entries> may indicate a number of buffer level entries, such as 1-8. A parameter <report_initial_playout_delay> may include an indication of whether a report of initial playout delay is required, for example “0” indicating “Report of initial playout delay is not required,” or “1” indicating “Report of initial playout delay is required.” A <meas_config_app_layer_id> parameter may indicate, at QoE measurement configuration, an identity for a QoE measurement configuration received in the <app-meas_config-file>. At QoE measurement configuration release, the <meas_config_app_layer_id> may indicate the measurement to be released. In some embodiments, an absence of the <meas_config_app_layer_id> parameter may indicate that all measurement configurations are released.

A <ran_visible_release_only> parameter may include an indication of whether all application level measurements for this <meas_config_app_layer_id> should be released, or only RAN visible application level measurements should be released, for example “0” indicating “Release the RAN visible application level measurements for this <meas_config_app_layer_id>,” or “1” indicating “Release all application level measurements for this <meas_config_app_layer_id>.”

With reference to FIGS. 4F and 4G, in some embodiments, the application processor (UE APP) may send an AT command (e.g., a Set command) such as +CAPPLEVMC=1, +CAPPLEVMCNR=1, +CAPPLEVMRNR=1, or +CAPPLEVMR=1, to the modem (UE AS). In some embodiments, the modem may respond with an unsolicited result code 474 or 476. In some embodiments, the AT command and the unsolicited result code 474 or 476 may relate to RAN Visible QoE (RVQoE) configuration and reporting. The unsolicited result code 474 or 476 may include a +CAPPLEVMC, +CAPPLEVMCNR, +CAPPLEVMRNR, or +CAPPLEVMR code that includes a variety of extensions, arguments, or parameters. Brackets indicate parameters that may be optionally included in the unsolicited result codes 474 and 476 in some embodiments. In some embodiments, the unsolicited result code 474 may include extensions, arguments, or parameters formatted to extend an application level measurement configuration of a +CAPPLEVMC (or +CAPPLEVMCNR) set command. In some embodiments, the unsolicited result code 474 may include extensions, arguments, or parameters formatted to extend an application level pause or resume+CAPPLEVMR (or +CAPPLEVMRNR) set command. In some embodiments, the unsolicited result code 474 or 476 may include one or more extensions, arguments, or parameters for RVQoE measurement configuration, which may include the RVQoE metrics to measure (e.g., buffer level, play list, playout delay), RVQoE value (e.g., a qualitative or numeric QoE score) and other configuration attributes such as periodicity for reporting RVQoE and an event trigger. In some embodiments, RVQoE parameters to be measured may include, for example, a <number_of_buffer_level_entries> parameter, a <report_initial_playout_delay> parameter, and a <app-meas_service_type> parameter. In some embodiments, the unsolicited result code 474 or 476 may include one or more extensions, arguments, or parameters for RVQoE measurement configuration and associated pause/resume of reporting are separate from and independent of currently-defined application measurement configuration and associated pause/resume of reporting. In some embodiments, the unsolicited result code 474 or 476 may include one or more extensions, arguments, or parameters for support for dedicated RVQoE measurement or application measurement configuration files for each application instance of a given service type, or a common RVQoE and application measurement configuration file for all application instances of that service type

With reference to FIG. 4H, in some embodiments, the application processor (UE APP) may send an action command 478, such as +CAPPLEVMR, to report one or more measurements (and/or a measurement report). In some embodiments the action command 478 may relate to RVQoE configuration and reporting. The action command 478 may include a variety of extensions, arguments, or parameters. Brackets indicate parameters that may be optionally included in the action command 478. In some embodiments, the action command 478 may include an application level measurement report action command to report existing application measurements and/or RVQoE measurements. In some embodiments, the modem (UE APP) may report application measurements and/or RVQoE measurements of a service type. In some embodiments, the modem may report such measurements in accordance with one or more previously-received configuration files for each measurement type.

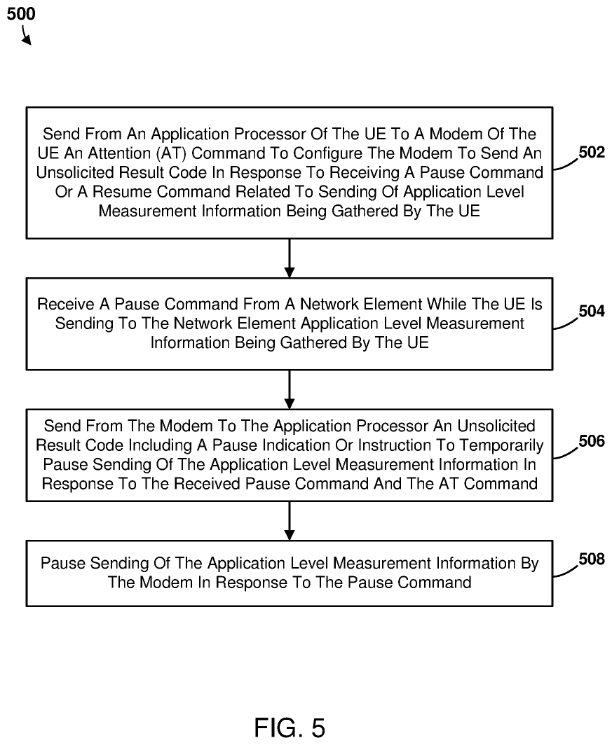

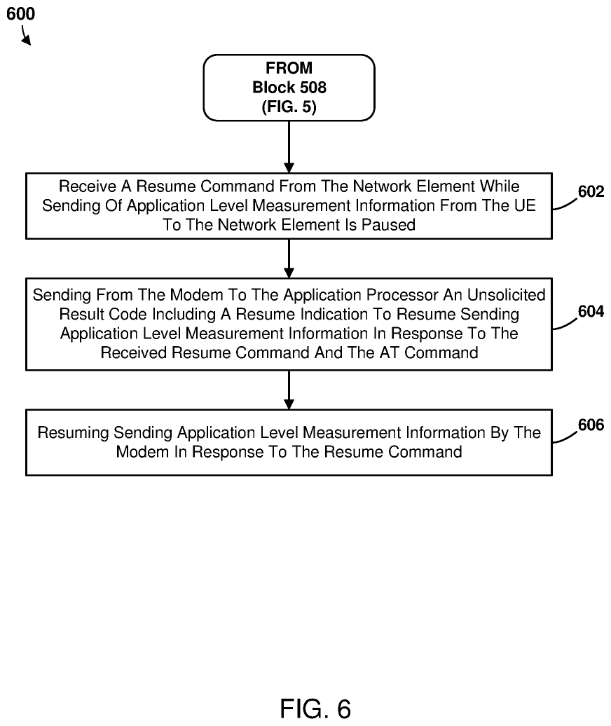

FIG. 5 is a process flow diagram illustrating a method 500 that may be performed by a UE for managing data measurement reporting in accordance with various embodiments. With reference to FIGS. 1-5, the method 500 may be implemented by processors (e.g., 210, 212, 214, 216, 218, 252, 260, 402, 404) of a UE (e.g., 120a-120e, 320).

In block 502, an application processor of the UE may send to a modem of the UE an AT command to configure the modem to send an unsolicited result code in response to receiving (e.g., by the modem) a pause command or a resume command related to sending of application level measurement information being gathered by the UE. For example, the application processor 404 may send the AT command 420 to the modem 402. Means for performing the operations of block 502 may include the application processor 216, 404 and the modem processor 212, 252, 402.

In block 504, the modem of the UE may receive a pause command from a network element while the UE (e.g., the modem) is sending to the network element application level measurement information being gathered by the UE. For example, the modem 402 may receive the message 426 including or indicating the pause command from the OAM 408 via the RAN 406. Means for performing the operations of block 504 may include the modem processor 212, 252, 402 and the wireless transceiver 266.

In block 506, the modem may send to the application processor an unsolicited result code including a pause indication or instruction to temporarily pause sending of the application level measurement information in response to the received pause command and the AT command. For example, the modem 402 may send the unsolicited result code 428 to the application processor 404. In some embodiments, the unsolicited result code including the pause indication or instruction may include an indication or instruction to pause (e.g., temporarily pause) the sending of all application level measurement information in response to the received pause command and the AT command. In some embodiments, the unsolicited result code including the pause indication or instruction may include an indication or instruction to temporarily pause the sending of a subset of all application level measurement information in response to the received pause command and the AT command. In some embodiments, the unsolicited result code including the pause indication or instruction may include an indication or instruction to temporarily pause the gathering of all application level measurement information in response to the received pause command and the AT command. In some embodiments, the unsolicited result code including the pause indication or instruction may include an indication or instruction to temporarily pause the gathering of a subset of all application level measurement information in response to the received pause command and the AT command. Means for performing the operations of block 506 may include the application processor 216, 404 and the modem processor 212, 252, 402.

In some embodiments, the unsolicited result code including the pause indication or instruction may indicate to or instruct the application processor to pause (e.g., temporarily pause) sending the application level measurement information from a specific application. In some embodiments, the unsolicited result code including the pause indication or instruction may indicate to or instruct the application processor to pause sending the application level measurement information from all currently running applications in the UE for which application level measurement information are being sent by the application processor to the modem. In some embodiments, the unsolicited result code including the pause indication may indicate to or instruct the application processor to pause sending of the application level measurement information from a subset of the currently running applications. For example, in some embodiments the unsolicited result code may include an indication of one or more application service instances that to be paused. In some embodiments, the unsolicited result code may include an indication of one or more application service application service types associated with certain application service instance(s). In some embodiments, the unsolicited result code including the pause indication also may include indication of whether to enable presentation of the unsolicited result code by the modem of the UE to the application processor of the UE (e.g., sending a notification from the modem of the UE to the application processor of the UE). In some embodiments, the unsolicited result code including the pause indication also may include an indication to the application processor to continue to gather application level measurement information and to store the gathered application level measurement information in an application layer memory.

In some embodiments, the unsolicited result code including the pause indication may include an indication or instruction to pause the gathering of RAN Visible QoE (RVQoE) metrics as separate application level measurement information in response to the received pause command and the AT command. In some embodiments, the unsolicited result code including the pause indication may include an indication of an application service instance associated with the RAN Visible QoE application level measurement information in accordance with information in an application measurement configuration file. In some embodiments, the unsolicited result code including the pause indication may include an indication of an application service type with which the application service instance, associated with the RAN Visible QoE application level measurement information, is associated.

In some embodiments, the unsolicited result code may include a pause indication to temporarily pause sending of the application level measurement information by the application processor. In some embodiments, the application level measurement information associated with the unsolicited result code may pertain to RAN Visible QoE metrics measurement information. In some embodiments, the unsolicited result code may include a pause indication or instruction to temporarily pause the sending of all application level measurement information by the application processor, a subset of application level measurement information corresponding to RAN-specific Visible QoE metrics measurement information, or a subset of application level measurement information not corresponding to RAN-specific Visible QoE metrics measurement information.

In some embodiments, the unsolicited result code also may include an indication or instruction to pause the collection of all application level measurement information by the application processor. In some embodiments, the unsolicited result code may include an indication or instruction to temporarily pause sending RAN Visible QoE application level measurement information. In some embodiments, the unsolicited result code may include a pause indication or instruction to temporarily pause both the sending of the application level measurement information and the collection of the application level measurement information by the application processor.

In block 508, the UE may pause sending of the application level measurement information by the modem in response to the pause command. For example, the modem 402 and the application processor 404 may pause the sending of the application level measurement information for all running applications, for a specific application, or for a subset of all running applications. In some embodiments, the application processor 404 may additionally pause performing application level measurement procedures for all running applications, the specific application, or for the subset of all running applications. Means for performing the operations of block 508 may include the application processor 216, 404 and the modem processor 212, 252, 402.

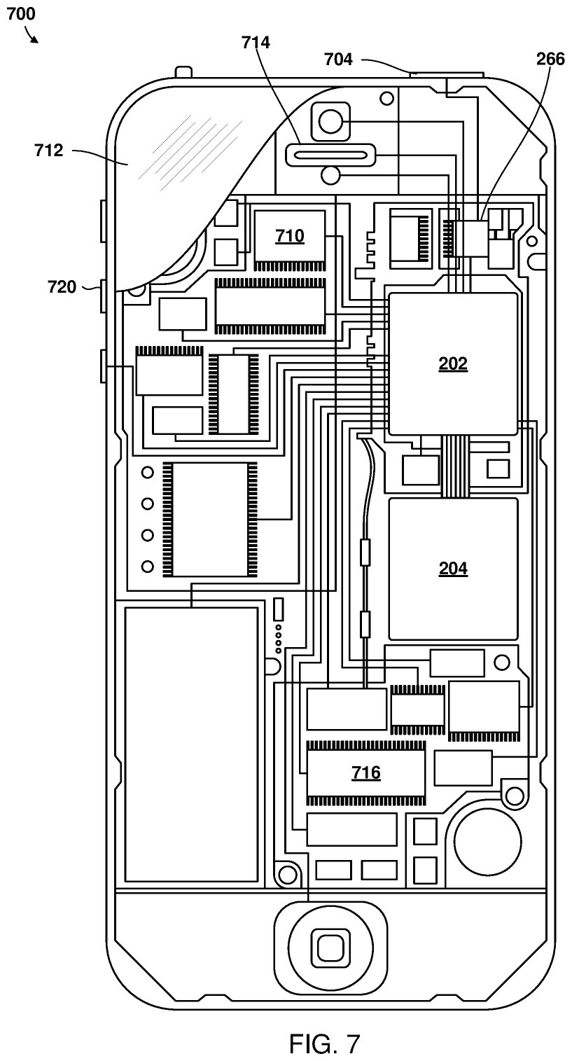

FIG. 6 is a process flow diagram illustrating operations 600 that may be performed by a UE as part of the method 500 for managing data measurement reporting in accordance with various embodiments. With reference to FIGS. 1-6, the operations 600 may be implemented by processors (e.g., 210, 212, 214, 216, 218, 252, 260, 402, 404) of a UE (e.g., 120a-120e, 320).

After pausing sending of the application level measurement information by the modem in response to the pause command in block 508 as described, the UE may receive a resume command from the network element. For example, the modem 402 may receive the message 438 including or indicating the resume command from the OAM 408 via the RAN 406. Means for performing the operations of block 602 may include the modem processor 212, 252, 402 and the wireless transceiver 266.

In block 604, the modem may send to the application processor an unsolicited result code including a resume indication to resume sending application level measurement information in response to the received resume command and the AT command. For example, in response to the received resume command in the message 438 and the AT command 420, the modem 402 may send the unsolicited result code 440 to the application processor 404. In some embodiments, the unsolicited result code including the resume indication also may include an indication for the application processor to resume a transfer of application level measurements to the modem. In some embodiments, the unsolicited result code including the resume indication may include an indication of all running applications, a specific application, or for a subset of all running applications for which the application processor had previously paused application level measurement information transfer to the modem. In some embodiments, the unsolicited result code including the resume indication may pertain to a subset of all currently running applications by including an indication of the running application service(s) for which the transfer of application level measurement information from the application processor to the modem should be resumed. In some embodiments, the unsolicited result code may include a resume indication that indicates to or instructs the application processor to resume the sending of a subset of the application level measurement information, for example, RAN Visible QoE application level measurement information.

In some embodiments, the unsolicited result code including the resume indication also may include an indication to apply one or more new application level measurement configuration files, corresponding to the application service(s) providing the application level measurement information. Means for performing the operations of block 604 may include the application processor 216, 404 and the modem processor 212, 252, 402.

In block 606, the UE may resume sending application level measurement information by the modem in response to the resume command. In some embodiments, resuming sending application level measurement information in response to the resume command may include resuming transfer of application level measurements for a specific application, all running applications, or for a subset of all running applications of the UE to the modem of the UE. In some embodiments, resuming sending of application level measurement information in response to the resume command may include transferring to the modem application level measurement information that is stored in memory. For example, in some embodiments, the application processor 404 may send an AT command 442 to the modem 402 that includes application level measurement information, and the modem 402 may send the application level measurement information to the RAN 406 in a message 446. Means for performing the operations of block 602 may include the modem processor 212, 252, 402, the application processor 216, 404, and the wireless transceiver 266.

FIG. 7 is a component block diagram of a UE 700 suitable for use with various embodiments. With reference to FIG. 1-7, various embodiments, including the method 500 and the operations 600, may be performed in a variety of UEs (e.g., the UEs 120a-120e, 320), such as the UE 700. The UE 700 may include a first SOC 202 (e.g., a SOC-CPU) coupled to a second SOC 204 (e.g., a 5G capable SOC). The first and second SOCs 202, 204 may be coupled to internal memory 716, a display 712, and to a speaker 714. Additionally, the UE 700 may include an antenna 704 for sending and receiving electromagnetic radiation that may be connected to a wireless data link and/or cellular telephone transceiver 266 coupled to one or more processors in the first and/or second SOCs 202, 204. The UE 700 may also include menu selection buttons or rocker switches 720 for receiving user inputs.

The UE 700 also may include a sound encoding/decoding (CODEC) circuit 710, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC 710 may include a digital signal processor (DSP) circuit (not shown separately).

The processors of the network computing device 700 and the UE 700 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within an SOC 204 dedicated to wireless communication functions and one processor within an SOC 202 dedicated to running other applications. Software applications may be stored in the memory 426, 430, 716 before they are accessed and loaded into the processor. The processors may include internal memory sufficient to store the application software instructions.

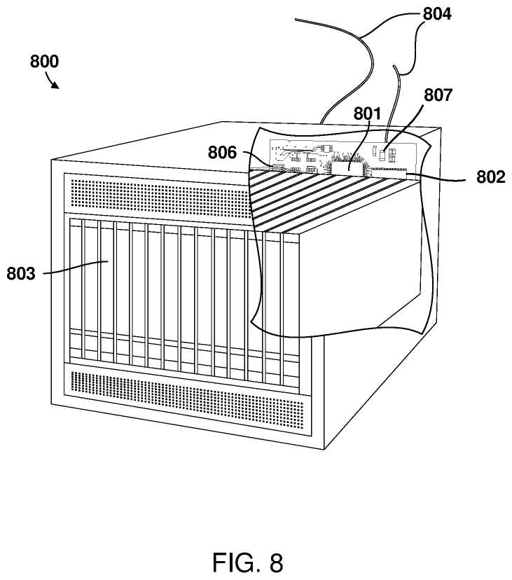

FIG. 8 is a component block diagram of a network computing device 800 suitable for use with various embodiments. With reference to FIGS. 1-8, various embodiments may be implemented on a variety of network computing devices, such as the network computing device 800, functioning as a network element of a communication network, such as a base station 110a-110d, 350, a network element of the RAN 406, the OAM 408, the TCE/MCE 410, etc. Such network computing devices may include at least the components illustrated in FIG. 8. The network computing device 800 may typically include a processor 801 coupled to volatile memory 802 and a large capacity nonvolatile memory, such as a disk drive 803. The network computing device 800 may also include a peripheral memory access device, such as a floppy disc drive, compact disc (CD) or digital video disc (DVD) drive 806 coupled to the processor 801. The network computing device 800 may also include network access ports 804 (or interfaces) coupled to the processor 801 for establishing data connections with a network, such as the Internet and/or a local area network coupled to other system computers and servers. The network computing device 800 may include one or more antennas 807 for sending and receiving electromagnetic radiation that may be connected to a wireless communication link. The network computing device 800 may include additional access ports, such as USB, Firewire, Thunderbolt, and the like for coupling to peripherals, external memory, or other devices.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a UE and the UE may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 500 and 600 may be substituted for or combined with one or more operations of the methods 500 and 600.

Implementation examples are described in the following paragraphs. While some of the following implementation examples are described in terms of example methods, further example implementations may include: the example methods discussed in the following paragraphs implemented by a UE including a processor configured to perform operations of the example methods; the example methods discussed in the following paragraphs implemented by a UE including a modem processor configured to perform operations of the example methods; the example methods discussed in the following paragraphs implemented by a UE including means for performing functions of the example methods; and the example methods discussed in the following paragraphs implemented as a non-transitory processor-readable storage medium having stored thereon processor-executable instructions configured to cause a processor or modem processor of a UE to perform the operations of the example methods.

Example 1. A method for managing data measurement reporting performed by a user equipment (UE), including sending from an application processor of the UE to a modem of the UE an attention (AT) command to configure the modem to send an unsolicited result code in response to receiving a pause command or a resume command related to sending of application level measurement information being gathered by the UE, receiving a pause command from a network element while the UE is sending to the network element application the level measurement information being gathered by the UE, sending from the modem to the application processor an unsolicited result code including a pause indication or instruction to temporarily pause sending of the application level measurement information in response to the received pause command and the AT command, and pausing sending of the application level measurement information by the modem in response to the pause command.

Example 2. The method of example 1, in which the unsolicited result code including the pause indication or instruction includes an indication or instruction to temporarily pause sending of all application level measurement information in response to the received pause command and the AT command.

Example 3. The method of either of examples 1 or 2, in which the unsolicited result code including the pause indication or instruction includes an indication or instruction to temporarily pause sending of at least a subset of all application level measurement information in response to the received pause command and the AT command.

Example 4. The method of any of examples 1-3, in which the unsolicited result code including the pause indication or instruction includes an indication or instruction to temporarily pause gathering of all application level measurement information in response to the received pause command and the AT command.

Example 5. The method of any of examples 1-4, in which the unsolicited result code including the pause indication or instruction includes an indication or instruction to temporarily pause gathering of at least a subset of all application level measurement information in response to the received pause command and the AT command.

Example 6. The method of any of claims 1-5, in which the unsolicited result code including the pause indication or instruction includes an indication of an application service instance providing the application level measurement information in accordance with information in an application measurement configuration file.

Example 7. The method of example 6, in which the unsolicited result code including the pause indication or instruction further includes an indication of an application service type associated with the application service instance.

Example 8. The method of any of examples 1-7, in which the AT command includes an indication of whether to enable presentation of the unsolicited result code by the modem of the UE to the application processor of the UE.

Example 9. The method of any of examples 1-8, in which the unsolicited result code including the pause indication or instruction includes an indication or instruction to the application processor to continue to gather application level measurement information and to store gathered application level measurement information according to configuration information in an application layer memory.

Example 10. The method of any of examples 1-9, in which the modem includes an access stratum of the UE and the application processor includes an application level of the UE.

Example 11. The method of any of examples 1-10, further including receiving a resume command from the network element while sending of application level measurement information from the UE to the network element is paused, sending from the modem to the application processor an unsolicited result code including a resume indication or instruction to resume sending application level measurement information according to configuration information in response to the received resume command and the AT command, and resuming sending application level measurement information by the modem in response to the resume command.

Example 12. The method of example 11, in which the unsolicited result code including the resume indication or instruction includes an indication for the application processor to resume a transfer of application level measurements to the modem, and resuming sending application level measurement information in response to the resume command includes resuming transfer of application level measurements by the application processor of the UE to the modem of the UE.

Example 13. The method of example 12, in which the unsolicited result code including the resume indication or instruction includes an indication or instruction to resume sending of all application level measurement information in response to the received resume command and the AT command.

Example 14. The method of example 12, in which the unsolicited result code including the resume indication or instruction includes an indication or instruction to resume sending of at least a subset of all application level measurement information in response to the received resume command and the AT command.

Example 15. The method of example 11, in which resuming sending of application level measurement information in response to the resume command includes transferring to the modem application level measurement information that is stored in application layer memory.

Example 16. The method of example 11, in which the unsolicited result code including the resume indication or instruction includes an indication of an application service instance to resume sending application level measurement information.

Example 17. The method of example 16, in which the unsolicited result code including the resume indication or instruction further includes an indication of an application service type associated with the application service instance.

Example 18. The method of example 11, in which the unsolicited result code including the resume indication or instruction includes an indication to apply a new application level measurement configuration file of an application service providing the application level measurement information.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for managing data measurement reporting performed by a user equipment (UE), comprising:
sending from an application processor of the UE to a modem of the UE an attention (AT) command to configure the modem to send an unsolicited result code in response to receiving a pause command or a resume command related to sending of application level measurement information being gathered by the UE;
receiving a pause command from a network element while the UE is sending to the network element the application level measurement information being gathered by the UE;
sending from the modem to the application processor an unsolicited result code comprising a pause indication or instruction to temporarily pause sending of the application level measurement information in response to the received pause command and the AT command; and
pausing sending of the application level measurement information by the modem in response to the pause command.

2. The method of claim 1, wherein the unsolicited result code comprising the pause indication or instruction comprises an indication or instruction to temporarily pause sending of at least a subset of all application level measurement information in response to the received pause command and the AT command.

3. The method of claim 1, wherein the unsolicited result code comprising the pause indication or instruction comprises an indication or instruction to temporarily pause gathering of at least a subset of all application level measurement information in response to the received pause command and the AT command.

4. The method of claim 1, wherein the unsolicited result code comprising the pause indication or instruction includes an indication of an application service instance providing the application level measurement information in accordance with information in an application measurement configuration file.

5. The method of claim 4, wherein the unsolicited result code comprising the pause indication or instruction further includes an indication of an application service type associated with the application service instance.

6. The method of claim 1, wherein the AT command includes an indication of whether to enable presentation of the unsolicited result code by the modem of the UE to the application processor of the UE.

7. The method of claim 1, wherein the unsolicited result code comprising the pause indication or instruction includes an indication or instruction to the application processor to continue to gather application level measurement information and to store gathered application level measurement information according to configuration information in an application layer memory.

8. The method of claim 1, further comprising:
receiving a resume command from the network element while sending of application level measurement information from the UE to the network element is paused;
sending from the modem to the application processor an unsolicited result code comprising a resume indication or instruction to resume sending application level measurement information according to configuration information in response to the received resume command and the AT command; and
resuming sending application level measurement information by the modem in response to the resume command.

9. The method of claim 8, wherein:
the unsolicited result code comprising the resume indication or instruction includes an indication for the application processor to resume a transfer of application level measurements to the modem; and
resuming sending application level measurement information in response to the resume command comprises resuming transfer of application level measurements by the application processor of the UE to the modem of the UE.

10. The method of claim 9, wherein the unsolicited result code comprising the resume indication or instruction comprises an indication or instruction to resume sending of at least a subset of all application level measurement information in response to the received resume command and the AT command.

11. The method of claim 8, wherein resuming sending of application level measurement information in response to the resume command comprises transferring to the modem application level measurement information that is stored in application layer memory.

12. The method of claim 8, wherein the unsolicited result code comprising the resume indication or instruction includes an indication of an application service instance to resume sending application level measurement information.

13. The method of claim 12, wherein the unsolicited result code comprising the resume indication or instruction further includes an indication of an application service type associated with the application service instance.

14. The method of claim 8, wherein the unsolicited result code comprising the resume indication or instruction includes an indication to apply a new application level measurement configuration file of an application service providing the application level measurement information.

15. A user equipment (UE), comprising:
an application processor; and
a modem, wherein:
the application processor is configured to send to the modem an attention (AT) command to configure the modem to send an unsolicited result code in response to receiving a pause command or a resume command related to sending of application level measurement information being gathered by the UE; and
the modem is configured to:
receive a pause command from a network element while the UE is sending to the network element the application level measurement information being gathered by the UE;
send to the application processor an unsolicited result code comprising a pause indication or instruction to temporarily pause sending of the application level measurement information in response to the received pause command and the AT command; and
pause sending of the application level measurement information in response to the pause command.

16. The UE of claim 15, wherein the unsolicited result code comprising the pause indication or instruction comprises an indication or instruction to temporarily pause sending of at least a subset of all application level measurement information in response to the received pause command and the AT command.

17. The UE of claim 15, wherein the unsolicited result code comprising the pause indication or instruction comprises an indication or instruction to temporarily pause gathering of at least a subset of all application level measurement information in response to the received pause command and the AT command.

18. The UE of claim 15, wherein the unsolicited result code comprising the pause indication or instruction includes an indication of an application service instance providing the application level measurement information in accordance with information in an application measurement configuration file.

19. The UE of claim 18, wherein the unsolicited result code comprising the pause indication or instruction further includes an indication of an application service type associated with the application service instance.

20. The UE of claim 15, wherein the AT command includes an indication of whether to enable presentation of the unsolicited result code by the modem of the UE to the application processor of the UE.

21. The UE of claim 15, wherein the unsolicited result code comprising the pause indication or instruction includes an indication or instruction to the application processor to continue to gather application level measurement information and to store gathered application level measurement information in an application layer memory.

22. The UE of claim 15, wherein the modem is further configured to:
receive a resume command from the network element while sending of application level measurement information from the UE to the network element is paused;
send to the application processor an unsolicited result code comprising a resume indication or instruction to resume sending application level measurement information according to configuration information in response to the received resume command and the AT command; and
resume sending application level measurement information in response to the resume command.

23. The UE of claim 22, wherein:
the unsolicited result code comprising the resume indication or instruction includes an indication for the application processor to resume a transfer of application level measurements to the modem; and
the modem is further configured to resume transfer of application level measurements by the application processor of the UE to the modem of the UE.

24. The UE of claim 23, wherein the unsolicited result code comprising the resume indication or instruction comprises an indication or instruction to resume sending of at least a subset of all application level measurement information in response to the received resume command and the AT command.

25. The UE of claim 22, wherein the application processor is further configured to transfer to the modem application level measurement information that is stored in application layer memory.

26. The UE of claim 22, wherein the unsolicited result code comprising the resume indication or instruction includes an indication of an application service instance to resume sending application level measurement information.

27. The UE of claim 26, wherein the unsolicited result code comprising the resume indication or instruction further includes an indication of an application service type associated with the application service instance.

28. The UE of claim 22, wherein the unsolicited result code comprising the resume indication or instruction includes an indication to apply a new application level measurement configuration file of an application service providing the application level measurement information.

29. A user equipment (UE), comprising:
an application processor;
a modem;
means for sending from the application processor to a modem an attention (AT) command to configure the modem to send an unsolicited result code in response to receiving a pause command or a resume command related to sending of application level measurement information being gathered by the UE;
means for receiving a pause command from a network element while the UE is sending to the network element application level measurement information being gathered by the UE;
means for sending from the modem to the application processor an unsolicited result code comprising a pause indication or instruction to temporarily pause sending of the application level measurement information in response to the received pause command and the AT command; and
means for pausing sending of the application level measurement information by the modem in response to the pause command.

30. A non-transitory processor-readable medium having stored thereon processor-executable instructions configured to cause a processing device in a user equipment (UE) to perform operations, comprising:
sending from an application processor of the UE to a modem of the UE an attention (AT) command to configure the modem to send an unsolicited result code in response to receiving a pause command or a resume command related to sending of application level measurement information being gathered by the UE;
receiving a pause command from a network element while the UE is sending to the network element application level measurement information being gathered by the UE;
sending from the modem to the application processor an unsolicited result code comprising a pause indication or instruction to temporarily pause sending of the application level measurement information in response to the received pause command and the AT command; and
pausing sending of the application level measurement information by the modem in response to the pause command.
